(19) United States
(12) Patent Application Publication
(10) Pub. No.: US 2013/0232034 A1
(43) Pub. Date: Sep. 5, 2013

(54) COORDINATE SUPPORTING SYSTEM, COORDINATE SUPPORTING APPARATUS AND COORDINATE SUPPORTING METHOD

(71) Applicant: TOSHIBA TEC KABUSHIKI KAISHA, Tokyo (JP)

(72) Inventor: Naoto Sano, Shizuoka-ken (JP)

(73) Assignee: TOSHIBA TEC KABUSHIKI KAISHA, Tokyo (JP)

(21) Appl. No.: 13/785,398

(22) Filed: Mar. 5, 2013

(30) Foreign Application Priority Data
Mar. 5, 2012 (JP) 2012-048502

(51) Int. Cl. G06Q 30/06

(52) U.S. Cl. CPC G06Q 30/0631
USPC 705/26.61; 705/26.7

(57) ABSTRACT

A coordinate supporting apparatus comprises a determination section configured to determine whether or not there is a combination of commodities realizing a given coordinate pattern according to the data of the commodities purchased by a customer and a storage section configured to accumulatively store the data of the combination of commodities in association with a customer feature data relating to preferences of the customer who purchases commodities of the combination if the determination section determines that there is a combination of commodities realizing the given coordinate pattern.

### CROSS-REFERENCE TO RELATED APPLICATION

This application is based upon and claims the benefit of priority from Japanese Patent Application No. 2012-048502, filed Mar. 5, 2012, the entire contents of which are incorporated herein by reference.

### FIELD

Embodiments described herein relate to a system, apparatus and method for supporting the coordinate of clothing, interiors and so on.

### BACKGROUND

A coordinate supporting system is known which provides the coordinate information of the commodities, as a reference information, purchased by a customer to another customer having trouble in coordinating clothing or accessory.

However, in the conventional system, the coordinate information provided to a customer is not always the information meeting preferences of the customer. Thus, it is troublesome for the customer receiving the coordinate information that the customer has to select the information meeting his/her preferences from the variety of coordinate information.

### BRIEF DESCRIPTION OF THE DRAWINGS

FIG. 1 is a schematic diagram illustrating a coordinate supporting system according to an embodiment;

FIG. 2 is a pattern diagram illustrating the format of a record stored in a store database managed by the store server of the system shown in FIG. 1;

FIG. 3 is a pattern diagram illustrating the format of a record stored in a commodity database managed by the commodity server of the system shown in FIG. 1;

FIG. 4 is a pattern diagram illustrating the format of a record stored in a member database managed by the member server of the system shown in FIG. 1;

FIG. 5 is a pattern diagram illustrating the data structure of a commodity classification table managed by the coordinate server of the system shown in FIG. 1;

FIG. 6 is a pattern diagram illustrating the data structure of a coordinate table managed by the coordinate server of the system;

FIG. 7 is a pattern diagram illustrating the format of a record stored in a coordinate database managed by the coordinate server of the system;

FIG. 8 is a block diagram illustrating the main components of a POS terminal in the system;

FIG. 9 is a block diagram illustrating the main components of an information terminal in the system;

FIG. 10 is a block diagram illustrating the main components of the coordinate server in the system;

FIG. 11 is a block diagram illustrating the main functional components of the system;

FIG. 12 is a flowchart illustrating the main procedures of a member transaction data reception processing carried out by the coordinate server of the system;

FIG. 13 is a flowchart illustrating the main procedures of a coordinate supporting processing carried out by the information terminal of the system;

FIG. 14 is a flowchart illustrating the main procedures of a coordinate inquiry reception processing carried out by the coordinate server of the system;

FIG. 15 is a schematic diagram illustrating an example of a member registration screen displayed on a panel display unit in the information terminal of the system;

FIG. 16 is a schematic diagram illustrating an example of a coordinate retrieval screen displayed on the panel display unit in the information terminal of the system;

FIG. 17 is a schematic diagram illustrating an example of a coordinate image screen displayed on the panel display unit in the information terminal of the system; and

FIG. 18 is a schematic diagram illustrating an example of a coordinate detail screen displayed on the panel display unit in the information terminal of the system.

### DETAILED DESCRIPTION

In accordance with an embodiment, a coordinate supporting apparatus comprises a determination section configured to determine whether or not there is a combination of commodities realizing a given coordinate pattern according to the data of the commodities purchased by a customer and a storage section configured to store the data of the combination of commodities in association with a customer feature data relating to preferences of the customer who purchases commodities of the combination if the determination section determines that there is a combination of commodities realizing the given coordinate pattern.

An embodiment of the coordinate supporting system is described below with reference to the accompanying drawings. In addition, in the embodiment, coordinate information is provided to a customer requesting support in the coordinate of clothing or interiors in each clothing chain store.

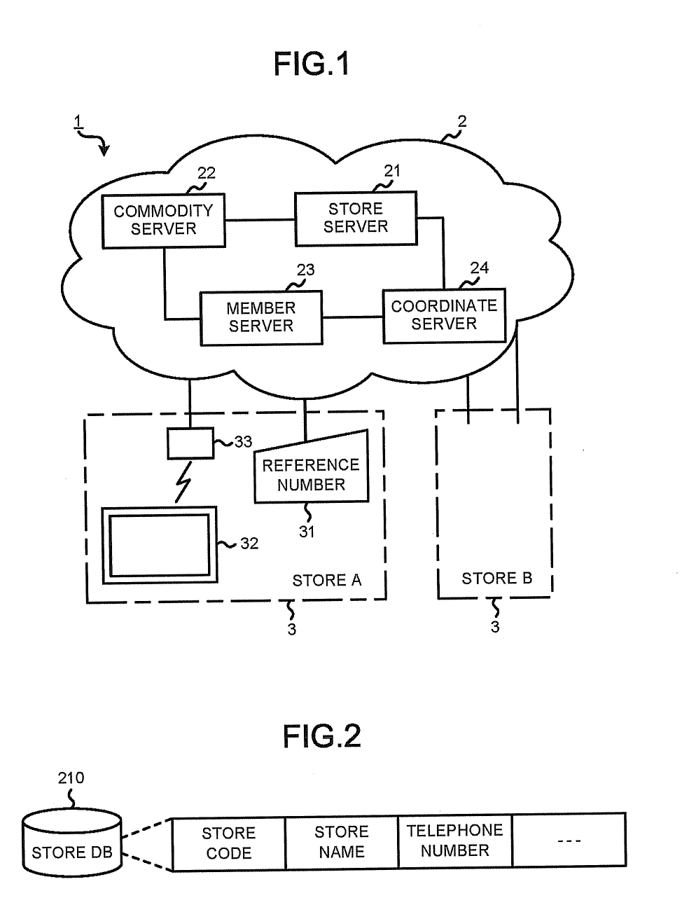

FIG. 1 is a schematic diagram illustrating a coordinate supporting system 1 according to the present embodiment. The system 1 comprises a cloud computing 2, and a store system 3 built for each chain store.

The cloud computing 2 comprises, based on a wire or wireless network (e.g. the Internet), a store server 21, a commodity server 22, a member server 23 and a coordinate server to provide given services in the form of a SaaS (Software as a Service) to the store system 3.

The store server 21 manages a store database 210. In the store database 210, a record for shop is accumulated in association with a unique or a proper store code set for each shop constituting a chain store to identify each shop, as shown in FIG. 2. The record for shop includes a shop information such as a store name and a telephone number.

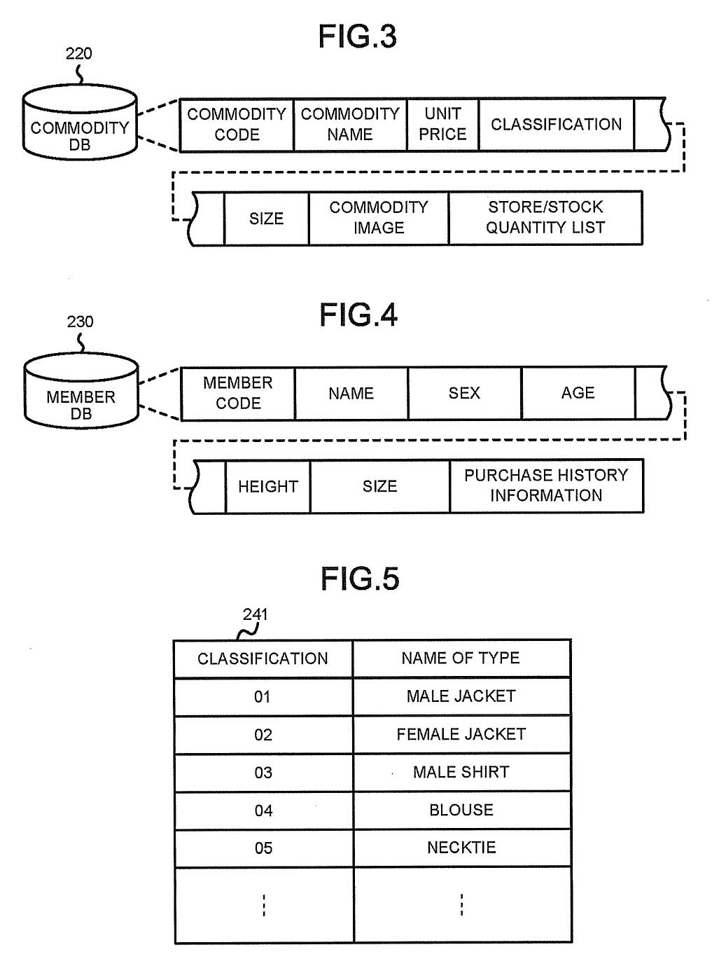

The commodity server 22 manages a commodity database 220. In the commodity database 220, a record for commodity is accumulatively stored in association with a proper commodity code set for each commodity to identity each commodity sold in a shop, as shown in FIG. 3. The record for commodity includes a commodity information such as a commodity name, a unit price, a commodity classification, a commodity size, a commodity image, and the quantity of stock in the shop. The commodity code assigned to the commodity is attached to the commodity in the form of a bar code.

The member server 23 manages a member database 230. In the member database 230, a record for member is accumulatively stored in association with a proper member code set for each member to identify each member in the shop, as shown in FIG. 4. The record for member includes a member information such as name, sex, age, height, clothing size and a purchase history. A member card on which the member code of a member is recorded is issued to the member.

The coordinate server 24 manages a commodity classification table 241, a coordinate table 242 and a coordinate database 240. As shown in FIG. 5, the group name of a clothing is set in the commodity classification table 241 in association with a proper commodity classification.

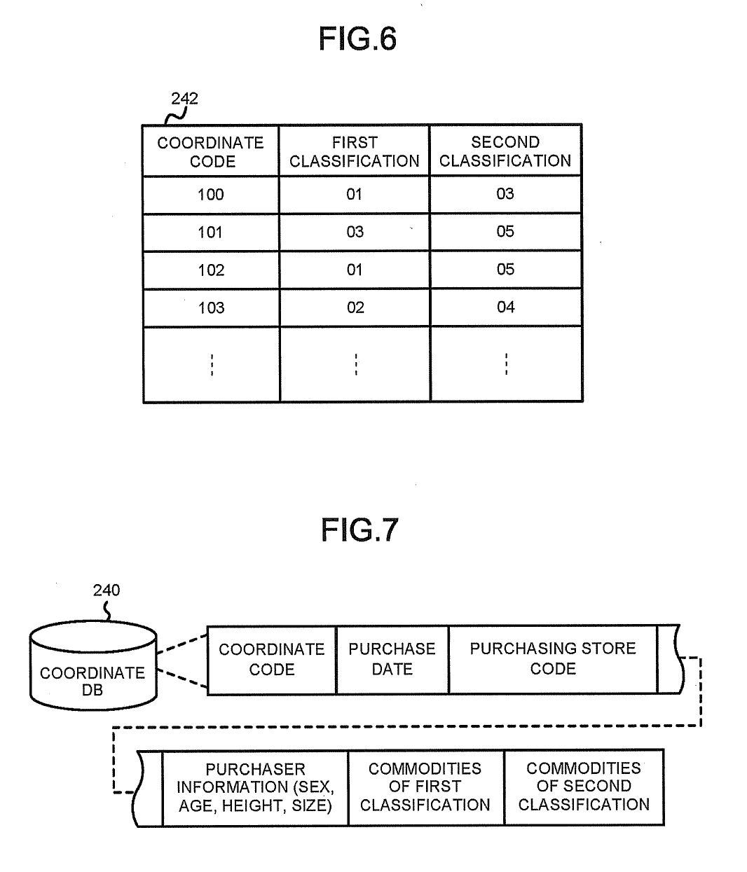

As shown in FIG. 6, commodity classifications of two kinds of clothing or interiors realizing or achieving a coordinate pattern are set in the coordinate table 242 in association with a proper coordinate code. That is, the combination of commodity classifications of two kinds of commodities purchased by a customer for coordinate, such as a jacket and a shirt, a jacket and a necktie, a blouse and a skirt, and a sweater and a shirt, are respectively set in association with different coordinate codes.

A coordinate record, in which information relating to the purchase transaction of two kinds of clothes or interiors forming a coordinate pattern is recorded, is stored in the coordinate database 240. That is, as shown in FIG. 7, a coordinate code for the coordinate pattern formed, a purchase date, a store record, purchaser information (e.g. sex, age, height and size of clothing) and codes of commodities of the first and second classifications are recorded as an information relating to the purchase transaction.

The following description will be given with reference to FIG. 1.

The store system 3 comprises a POS (Point Of Sales) terminal 31, an information terminal 32 having a wireless communication function therein and a wireless base station 33 for conducting a wireless communication with the information terminal 32. The POS terminal 31 is connected with the network of the cloud computing 2 via a LAN (Local Area Network). The information terminal 32 is a portable wireless communication apparatus and is connected with the network of the cloud computing 2 via the wireless base station 33.

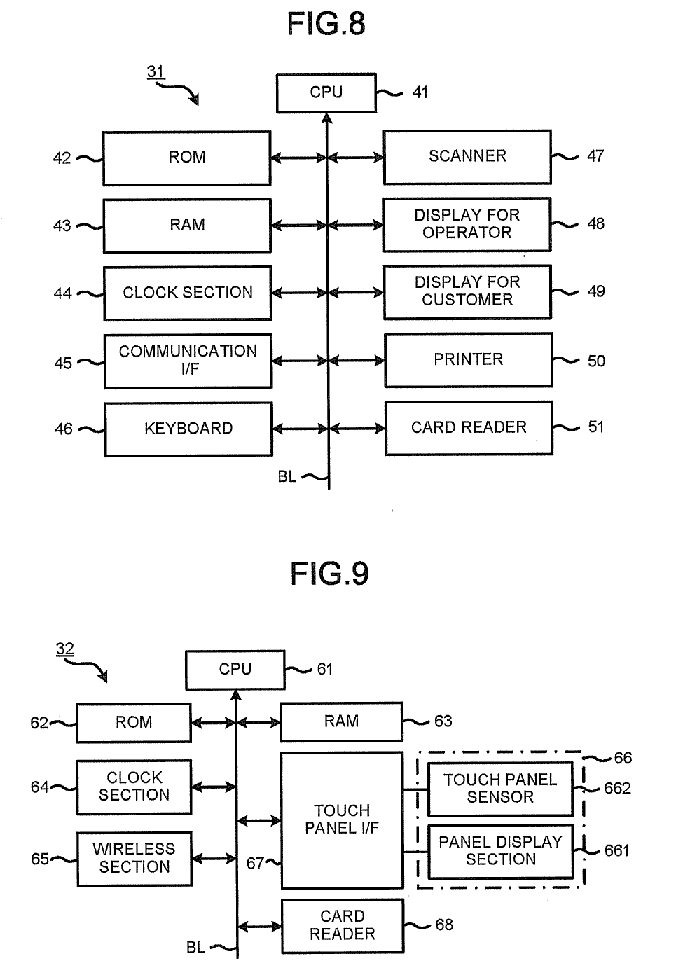

FIG. 8 is a block diagram illustrating the main components of the POS terminal 31. The POS terminal 31 is provided with a CPU (Central Processing Unit) 41 as the main body of a control unit. The CPU 41 is connected with a bus line BL such as an address bus, a data bus and the like. A ROM (Read Only Memory) 42, a RAM (Random Access Memory) 43, a clock section 44 and a communication interface 45 are connected to the bus line BL. In addition, various input/output devices, including a keyboard 46, a scanner 47, a display for operator 48, a display for customer 49, a printer 50 and a card reader 51, are also connected with the bus line BL via an I/O (Input/Output) controller (not shown).

Numeric keys for inputting numerical data, and a closing key for declaring the closing of the registration in one commodity transaction are arranged on the keyboard 46. The scanner 47 optically reads the barcode attached on a commodity. The commodity name and the price of a commodity purchased by a customer are displayed on the display 48 for operator and the display 49 for customer. The printer 50 prints and issues a receipt. The card reader 51 reads the data in the member card held by a customer who is a member of the shop.

FIG. 9 is a block diagram illustrating the main components of the information terminal 32. The information terminal 32 is also provided with a CPU 61 as the main body of a control unit. Moreover, the CPU 61 is connected with a bus line BL, and a ROM 62, a RAM 63, a clock section 64 and a wireless section 65 are also connected with the bus line BL. In addition, for example, the interface 67 for a touch panel 66, and a card reader 68 are connected with the bus line BL. The touch panel 66 includes a touch panel sensor 662 mounted on the screen of a panel display unit 661 composed of a liquid crystal display.

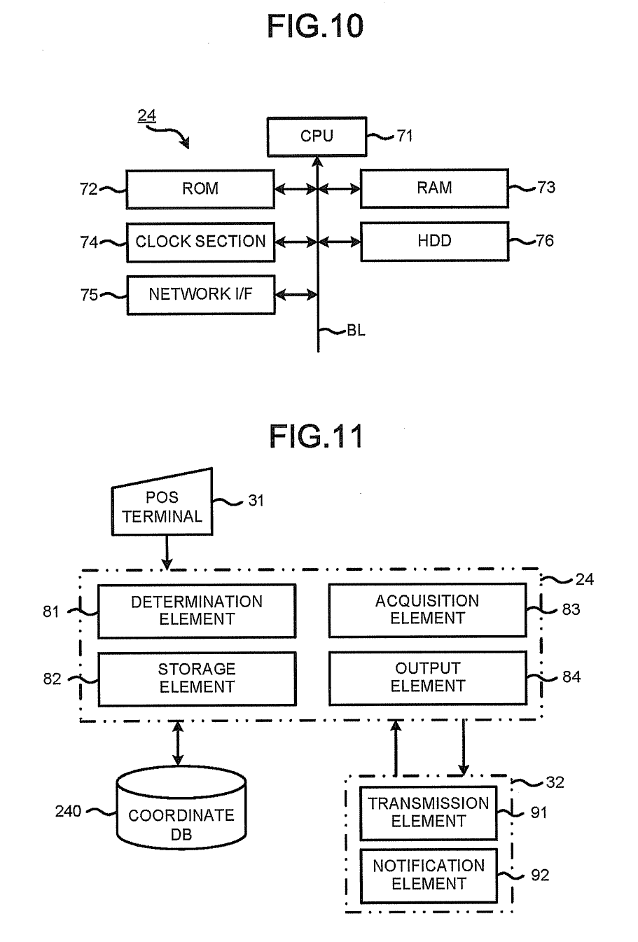

FIG. 10 is a block diagram illustrating the main components of the coordinate server 24. The coordinate server 24 is also provided with a CPU 71 as the main body of a control unit. The CPU 71 is connected with a bus line BL, and a ROM 72, a RAM 73, a clock section 74 and a network interface 75 are also connected with the bus line BL. Further, a HDD (Hard Disk Drive) device 76 as a high-capacity memory is connected with the bus line BL via an I/O (Input/Output) controller (not shown). The coordinate database 240 is stored in the HDD device 76.

The coordinate server 24 with the above structure functions as a determination element 81, a storage element 82, an acquisition element 83 and an output element 84, as shown in FIG. 11. The determination element 81 determines, according to the data of the commodities purchased by a customer, whether or not there is a combination of commodities realizing a given coordinate pattern. The data of the commodities purchased by the customer is sent from the POS terminal 31. If the determination element 81 determines that there is a combination of commodities realizing the coordinate pattern, the storage element 82 stores the data of the combination of commodities in the coordinate database 240 in association with a customer feature data relating to preferences of the customer who purchases the commodities of such combination. The acquisition element 83 compares a person feature data relating to preferences of the person who requests the coordinate support with the customer feature data associated with the data of the combination of commodities of each customer stored in the coordinate database 240 to acquire the data of a combination of commodities associated with the customer feature data similar to the person feature data. The output element 84 outputs the data of the combination of commodities acquired by the acquisition element 83 to the information terminal 32. Functions of the determination element 81, the storage element 82, the acquisition element 83 and the output element 84 are achieved by the CPU 71 acting in accordance with a server side coordinate supporting program stored in the ROM 72.

On the other hand, the information terminal 32 includes functions as a transmission element 91 and a notification element 92. The transmission element 91 sends person feature data relating to preferences of the person who requests a coordinate support to the coordinate server 24. The notification element 92 receives the data of the combination of commodities output from the coordinate server 24 and notifies it. The functions of the transmission element 91 and the notification element 94 are realized by the CPU 61 acting according to a terminal side coordinate supporting program stored in the ROM 62.

The functions of the aforementioned coordinate server 24 and information terminal 32 will be understood from the following function description. First, the functions achieved between the POS terminal 31 and the cloud computing 2 are described.

When the data in a member card is read by the card reader 51, the POS terminal 31 inquires of the cloud computing 2 about member data via the communication interface 45. The member server 23 in the cloud computing 2 actuates in response to the inquiry. The member server 23 retrieves the member database 230 using the member code contained in the data of the member card. Then, if the member server 23 detects a member record containing the member code, the member server 23 sends the member record to the POS terminal 31 that is an inquiry source. The POS terminal 31 stores data of the member record received from the member server 23 in the transaction area of the RAM 43.

When the commodity code (barcode) of a commodity purchased by a customer is read by the scanner 47, the POS terminal 31 inquires of the cloud computing 2 about commodity data via the communication interface 45. The commodity server 22 in the cloud computing 2 actuates in response to the inquiry. The commodity server 22 retrieves the commodity database 220 using the commodity code read by the scanner 47. Then, if the commodity server 22 detects a commodity record containing the commodity code, the commodity server 22 sends the commodity record to the POS terminal 31 that is an inquiry source. The POS terminal 31 generates commodity sales data based on the commodity name, unit price, commodity classification and commodity size contained in the commodity record received from the commodity server 22. Then, the POS terminal 31 stores the commodity sales data in the transaction area. Moreover, the POS terminal 31 displays the commodity name and the unit price on the display 48 for operator and the display 49 for customer.

When the closing key on the keyboard 46 is operated, the POS terminal 31 executes the closing processing in one commodity transaction based on the member data and commodity sales data stored in the transaction area. Then, the printer 50 is activated to issue a receipt which shows the details of the one commodity transaction. The POS terminal 31 further generates member transaction data containing the member data and commodity sales data stored in the transaction area, the current date/time (transaction date and time) timed by the clock section 44 and a preset store code and sends the generated data to the cloud computing 2 via the communication interface 45.

The commodity server 22, the member server 23 and the coordinate server 24 operate in the cloud computing 2 receiving the member transaction data, the commodity server 22 updating a stock quantity list in each shop based on the store code and commodity sales data contained in the member transaction data, and the member server 23 updating purchase history information based on the transaction date/time, the member data and the commodity sales data.

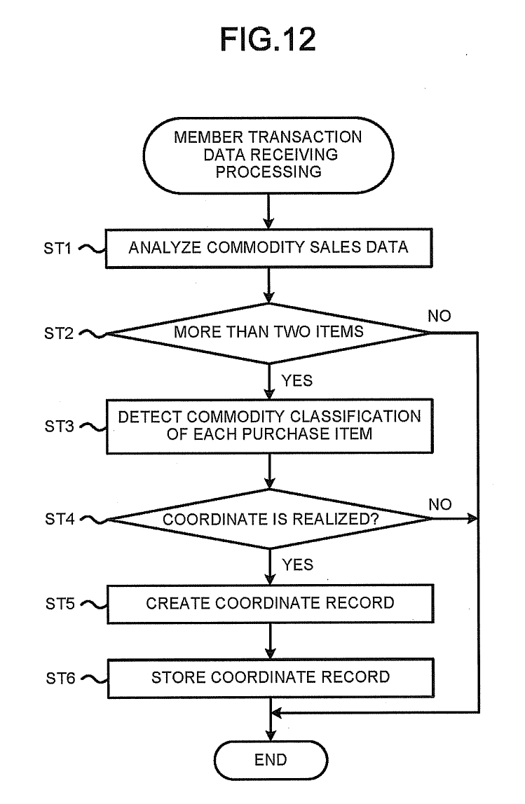

On the other hand, the server side coordinate supporting program is started in the coordinate server 24. Then, the CPU 71 starts to carry out the processing of the procedures shown in FIG. 12 according to the server side coordinate supporting program. First, the commodity sales data is analyzed (ST1) to determine whether or not the commodity sales data is a transaction data including more than two purchase items (ST2). The processing is ended if the transaction data includes only one purchase item (NO in ST2).

If there are more than two purchase items (YES in ST2), the CPU 71 detects the commodity classification of each purchase item (ST3). Then, the detected commodity classifications are used to check the coordinate table 242 to determine whether or not a given coordinate pattern is realized. That is, the commodity classifications detected are used to determine whether or not there is a combination of a first and second classifications corresponding to each coordinate code realized (ST4). If there is no combination realized (NO in ST4), the processing is ended.

In the case in which there is a combination of a first and second classifications realized corresponding to at least one coordinate code (YES in ST4), the CPU 71 creates a coordinate record for each coordinate pattern to which a combination is realized. That is, a coordinate record is created according to the realized coordinate code, the transaction date/time (purchase date) and store code (code of the store from where commodities are purchased) contained in the member transaction data, member data (purchaser information), the code of the purchased commodity belonging to the first classification and the code of the purchased commodity belonging to the second classification (ST5). Thereafter, the CPU 71 additionally stores the created coordinate record in the coordinate database 240 (ST6). Then the processing is ended.

The coordinate server 24 functions as the determination element 81 by executing ACTs ST2, ST3 and ST4, and also as the storage element 82 by executing ACTs ST5 and ST6.

The operations executed between the information terminal 32 and the cloud computing 2 are described below.

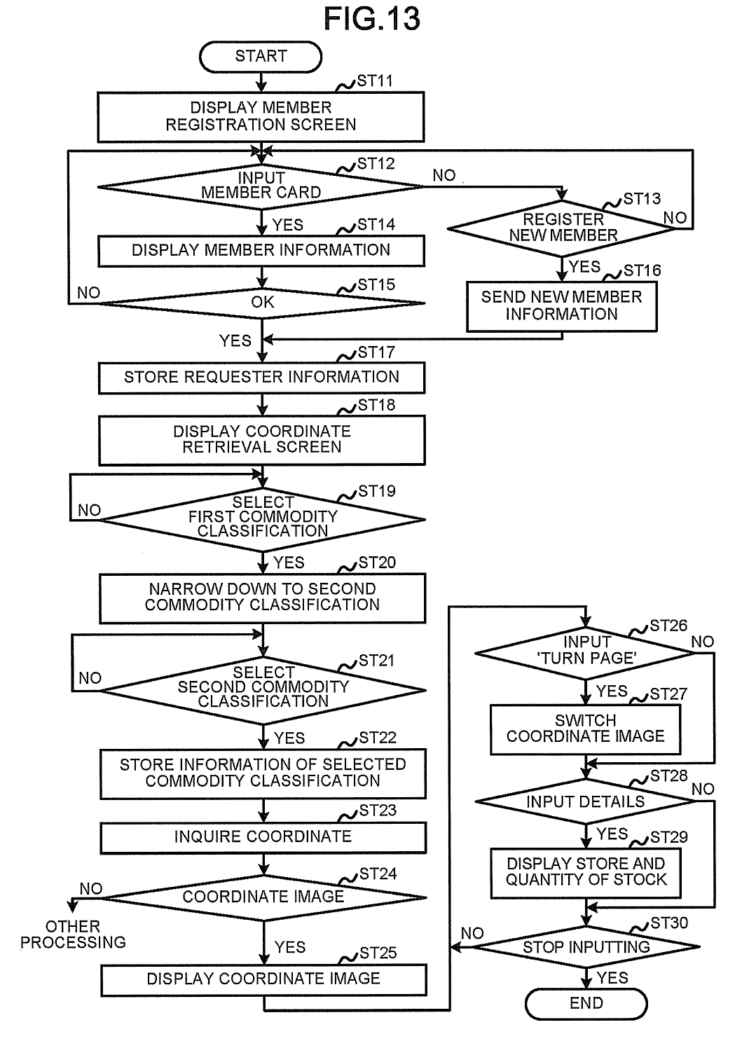

The information terminal 32 is used when a shop clerk is asked a coordinate advice from a customer. That is, the shop clerk who is asked a coordinate advice operates the touch panel 66 of the information terminal 32 to start a coordinate supporting service. The terminal side coordinate supporting program is started in the information terminal 32. Then, the CPU 61 starts the processing of the procedures shown in FIG. 13 according to the program. First, the CPU 61 displays a member registration screen 100 on the panel display unit 661 of the touch panel 66 (ST11).

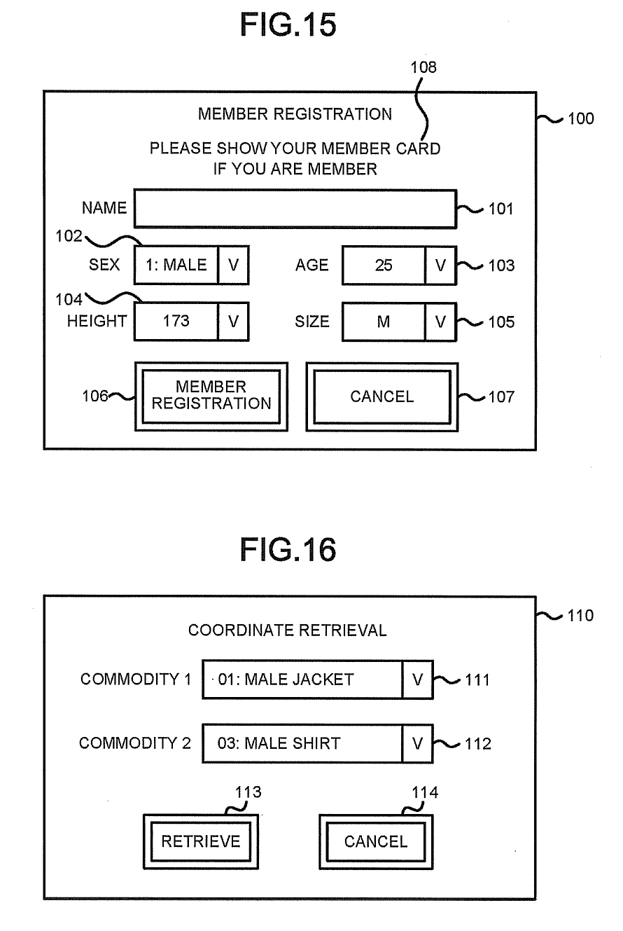

FIG. 15 shows a display example of the member registration screen 100. As shown in the diagram, an input box 101 for inputting a name, select boxes 102, 103, 104 and 105 for selecting sex, age, height and clothing size, a ‘member registration’ button 106 and a ‘cancel’ button 107 are arranged on the member registration screen 100. Moreover, a message 108 ‘Please show your member card if you are a member’ is also displayed on the member registration screen 100. Thus, the shop clerk confirms whether or not the customer (requester) requesting for a coordinate advice is a member. If the requester is a member, the shop clerk sets the member card taken from the member on the card reader 68 to read the card data of the member card, otherwise, the shop clerk asks the requester about his/her name, sex, age, height and clothing size which are necessary for the registration of a new member and then inputs these information to the boxes 101-105. Then, the shop clerk touches the ‘member registration’ button 106. Additionally, if there is an error in input, the shop clerk touches the ‘cancel’ button 107.

The CPU 61 activating the display of the member registration screen 100 waits for the input of the data of the member card (ST12) or the items necessary for the registration of a new member (ST13). When the data of the member card is read by the card reader (YES in ST12), the CPU 61 inquires of the cloud computing 2 about member data via the wireless section 65.

The member server 23 operates in the cloud computing 2 in response to the inquiry. The member server 23 retrieves the member database 230 using the member code in the data of the member card. Then, if the member server 23 detects a member record containing the member code, then the member server 23 sends the member record to the information terminal 32 of the inquiry source.

The information terminal 32 acquires name, sex, age, height and clothing size according to the data of the member record received from the member server 23 and displays the acquired information in the boxes 101-105 on the member registration screen 100 (ST14). At this time, the ‘member registration’ button 106 is switched to a ‘OK’ button. The CPU 61 waits for the input of the ‘OK’ button 106 or the ‘cancel’ button 107 (ST15).

The shop clerk confirms the contents displayed in the boxes 101-105. Then, if the contents displayed in the boxes 101-105 are correct, the shop clerk touches the ‘OK’ button 106. If the contents displayed in the boxes 101-105 are incorrect, the shop clerk touches the ‘cancel’ button 107. If the ‘cancel’ button 107 is touched (NO in ST15), the CPU 61 waits again for the input of the data of the member card (ST12) or the items necessary for the registration of a new member (ST13).

If the ‘OK’ button 106 is touched (YES in ST15), the CPU 61 stores the sex, age, height and clothing size contained in the received member record in the RAM 63 as a customer feature data relating to the preferences of the requester, that is, a requester information (ST17).

On the other hand, when the name, sex, age, height and clothing size are input to the boxes 101-105 on the member registration screen 100 based on a signal from the touch panel sensor 662, and then the ‘member registration’ button 106 is touched, the CPU 61 sends the input information in the boxes 101-105 to the cloud computing 2 via the wireless section 65 as anew member registration information.

The member server 23 operates in the cloud computing 2 in response to the transmission of the new member registration information. That is, after issuing a new member code, the member server 23 generates a member record in which the new member registration information is set in association with the new member code, and then adds the new member record in the member database 230.

The CPU 61 of the information terminal 32 sending the new member registration information stores the sex, age, height and clothing size contained in the new member registration information in the RAM 63 as a requester information (ST17).

When the requester information is stored in the RAM 63, then the CPU 61 switches the screen on the panel display section 661 to a coordinate retrieval screen 110 (ST18).

FIG. 16 shows a display example of the coordinate retrieval screen 110. As shown in FIG. 16, boxes 111 and 112 for selecting two kinds of commodity classification ‘commodity 1’ and ‘commodity 2’ for coordinate, a ‘retrieval’ button 113 and a ‘cancel’ button 114 are displayed on the coordinate retrieval screen 110.

The shop clerk asks the requester two kinds of commodity classifications for coordinate. Then, the two kinds of commodity classifications answered by the requester are selected on boxes 111 and 112, respectively. For example, in the case in which a male requester desires the coordinate of a jacket and a necktie, a commodity classification ‘gentleman jacket’ is selected on the ‘commodity 1’ box 111, and a commodity classification ‘necktie’ is selected on the ‘commodity 2’ box 112. In an other way, the commodity classification ‘necktie’ may be selected on the ‘commodity 1’ box 111, and the commodity classification ‘gentleman jacket’ may be selected on the ‘commodity 2’ box 112.

After displaying the coordinate retrieval screen 110, the CPU 61 waits for the selection of any one of commodity classifications on the ‘commodity 1’ box 111. When the commodity classification is selected (YES in ST19), the CPU 61 retrieves the coordinate table 242 to detect all of other commodity classifications which realize the coordinate pattern together with the selected commodity classification. Then, all the detected commodity classifications are narrowed down to the classifications that can be selected on the ‘commodity 2’ box 112 (ST20). For example, if the commodity classification selected on the ‘commodity 1’ box 111 is ‘male jacket’, then the commodity classifications that can be selected on the ‘commodity 2’ box 112 are narrowed down to ‘male shirt’, ‘necktie’ and the like, but ‘female jacket’ and ‘blouse’ are eliminated from the selected items.

Next, the CPU 61 waits for the selection of any one of the commodity classifications on the ‘commodity 2’ box 112 (ST21). When a commodity classification is selected (YES in ST21), the CPU 61 stores the data of a pair of commodity classifications selected on the ‘commodity 1’ box 111 and the ‘commodity 2’ box 112 in the RAM 63 (ST22). Then, the CPU 61 creates a coordinate inquiry command using the requester information (sex, age, height and clothing size) stored by the process in the ACT ST17 and the data of the pair of commodity classifications stored by the process in the ACT ST 22. The CPU 61 sends the inquiry command to the cloud computing 2 via the wireless section 65 (ST23).

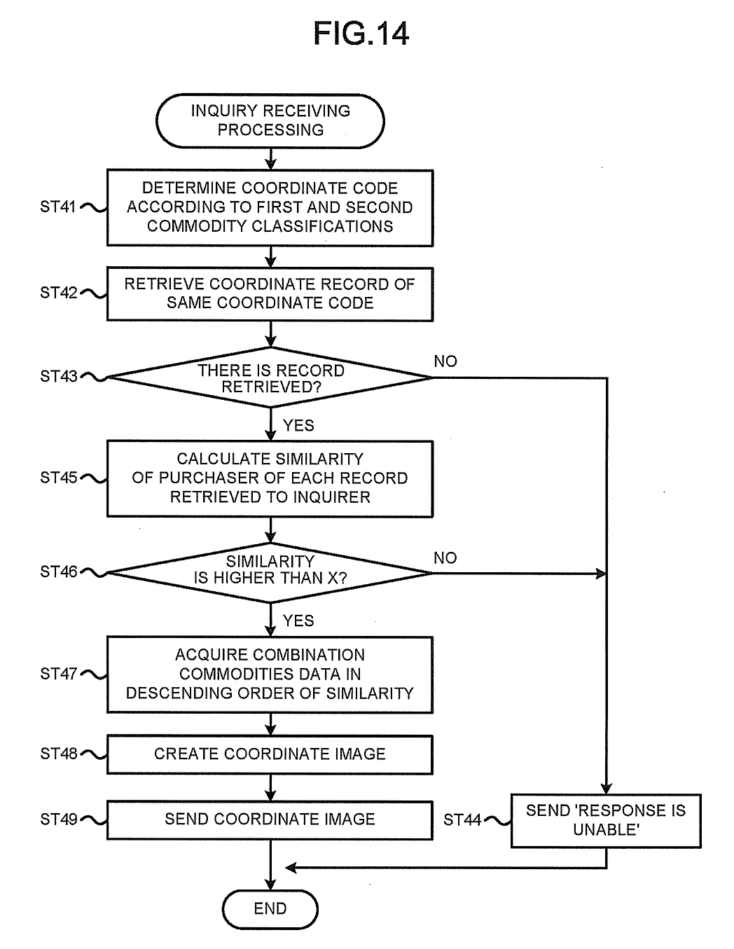

The coordinate server 24 in the cloud computing 2 operates in response to the inquiry command. That is, the CPU 71 of the coordinate server 24 reads the coordinate code assigned to the pair of commodity classifications in the command, referring to the coordinate table 242, as shown in the flowchart of FIG. 14.

Next, the CPU 71 retrieves the coordinate database 240, using the coordinate code (ST42), and determinates whether or not there is a coordinate record in which the same coordinate code is set (ST43). If no coordinate record in which the same coordinate code is set presents in the coordinate database 240 (NO in ST43), the CPU 71 sends a response command indicating that the response is unable to the information terminal 32 of the inquiry source (ST44).

In contrast, if at least one coordinate record in which the same coordinate code is set is found (YES in ST43), the CPU 71 acquires the purchaser information from the coordinate record. Then, the CPU 71 checks the purchaser information with the requester information in the inquirer command to calculate the similarity K of the requester against the purchaser (ST45).

For example, if the items ‘sex’ in the purchaser information and the requester information are coincided with one another, ‘1’ is output and otherwise, then ‘0’ is output as a determined similarity value A. If the items ‘age’ in the purchaser information and the requester information are coincided with one another, then ‘50’ is output as a determined similarity value B, and each difference ‘one year’ between the purchaser and the requester brings a reduction of 5 from the determined similarity value B. If the items ‘height’ in the purchaser information and the requester information are coincided with one another, then ‘50’ is output as a determined similarity value C, and each difference ‘1 cm’ between the purchaser and the requester brings a reduction of 5 from the determined similarity value C. If the items ‘clothing size’ in the purchaser information and the requester information are coincided with one another, then ‘1’ is output as a determined similarity value D. If the purchaser information and the requester information are not coincided with one another, ‘0’ is output as a determined similarity value D. In addition, the minimum value of the determined similarity values B and C is ‘0’.

Then, the CPU 71 calculates the similarity K by the following formula:

K=A*(B+C)*D (1)

For each of such coordinate records, when the similarity K of the requester against the purchaser in the record is calculated, the CPU 71 determines whether or not there is a coordinate record in which the calculated similarity K is higher than a preset threshold X (ST46). If there is no coordinate record in which the similarity Kis higher than the threshold X (NO in ST46), then the CPU 71 sends a response command indicating that ‘response is unable’ to the information terminal 32 of the inquiry source (ST44).

In contrast, if there is at least one coordinate record in which the similarity K is higher than the threshold X (YES in ST46), the CPU 71 selects coordinate records in the descending order of the similarity K. Then, the commodity codes of the first and second classifications are acquired from the coordinate record each time a coordinate record is selected. Then, a commodity image and stock quantity list for each shop corresponding to the commodity code of the first classification as well as a commodity image and stock quantity list for each shop corresponding to the commodity code of the second classification are read from the commodity database 220 managed by the commodity server 22 (ST47).

The CPU 71 creates, according to the commodity images corresponding to the commodity codes of the first and second classifications, a coordinate image G by overlapping the two images (ST48). The CPU 71 sends the information of the created coordinate image G with the stock quantity list for each shop corresponding to the commodity code of the first classification and the stock quantity list for each shop corresponding to the commodity code of the second classification to the information terminal 32 of the inquiry command transmission source (ST49).

The CPU 61 of the information terminal 32 sending the inquiry command in ACT ST23 waits for a response from the coordinate server 24 (ST24). Then, if the CPU 61 receives response data containing the information of the coordinate image G (YES in ST24), the CPU 61 displays, on the panel display section 661 of the touch panel 66, the coordinate image G created according to the coordinate record having the highest similarity K (ST25).

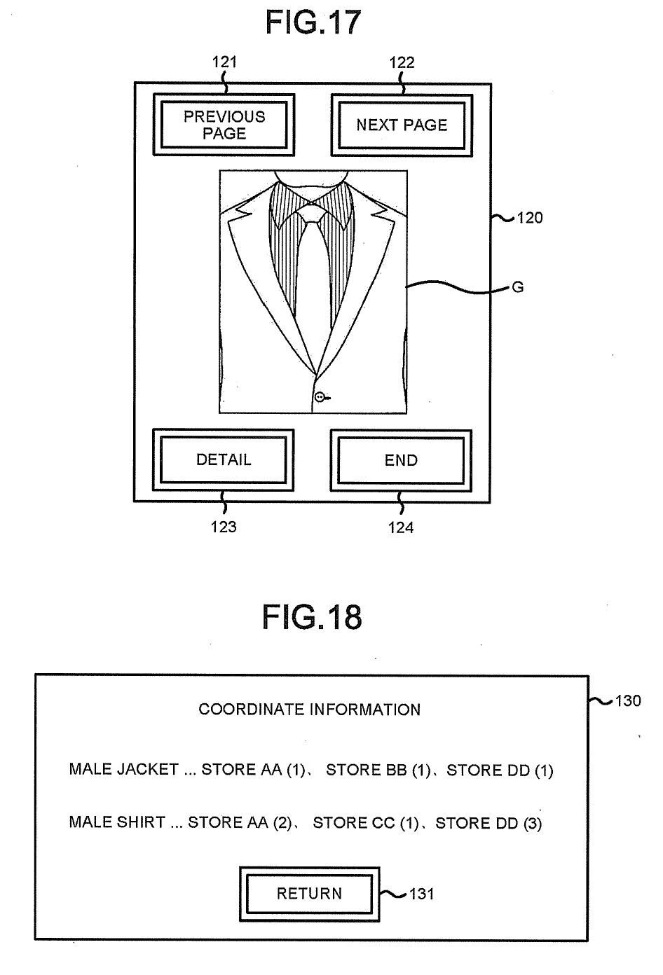

FIG. 17 shows a display example of the coordinate image G. The image G of a coordinate realizing the coordinate pattern of commodity classifications ‘male jacket’ and ‘necktie’ is shown in FIG. 17. As shown in FIG. 17, a ‘previous page’ button 121, a ‘next page’button 122, a ‘detail’ button 123 and an ‘end’ button 124 are displayed on the screen 120 of the coordinate image G. Additionally, the ‘previous page’ button 121 is inoperable (invalid) on the screen 120 of the coordinate image G having the highest similarity K. Simirally, the ‘next page’ button 122 is inoperable (invalid) on the screen 120 of the coordinate image G having the lowest similarity K.

The CPU 61 waits for the input of any one of the buttons on the screen 120 (ST26, 28 and 30). If the ‘previous page’ button 121 or the ‘next page’ button 122 is touched to input (YES in ST26), the CPU 61 switches the coordinate image G. That is, if the ‘previous page’ button 121 is touched to input, the coordinate image G is switched to a coordinate image G which is one rank higher in the similarity K than the coordinate image G being displayed. On the contrary, if the ‘next page’ button 122 is touched to input, the coordinate image G is switched to a coordinate image G which is one rank lower in the similarity K than the coordinate image G being displayed (ST27).

When the ‘detail’ button 123 is touched (YES in ST28), the CPU 61 acquires the stock quantity list for each shop corresponding to the first classification commodity code and the stock quantity list for each shop corresponding to the second classification commodity code added to the information of the coordinate image G being displayed. Then, a screen 130 showing the quantity of stock of the commodities of the first classification commodity code and the commodities of the second classification commodity code for each shop are displayed (ST28).

FIG. 18 shows a display example of the quantity of stock for each shop. A ‘return’ button 131 is displayed on the screen 130 in FIG. 18. When the ‘return’ button 131 is touched, the screen being displayed returns to the screen 120 showing the immediately preceding coordinate image G.

When the ‘end’ button 124 is touched (YES in ST30), the processing is ended.

Here, the CPU 71 of the coordinate server 24 executing the processes in ACTs ST41-ST47 functions as the acquisition element 83, and the processes in ACT ST48 and ACT ST49 function as an image creation element and an output element 84, respectively.

Moreover, the CPU 61 of the information terminal 32 executing the processes in ACTs ST11-ST23 and the process in ACT ST25 functions as the transmission element 91 and the notification element 92, respectively.

In the coordinate server 24 of the present embodiment, whether or not there is a combination of commodities realizing a given coordinate pattern is determined according to the member transaction data sent from the POS terminal 31. Then, if it is determined that there is a combination of commodities realizing the given coordinate pattern, a coordinate record representing the data of the combination of commodities is created and stored in the coordinate database 240.

The information of the combination of commodities realizing the given coordinate pattern is recorded in the coordinate record in association with customer feature data relating to his/her preference such as, the age, sex, height and clothing size of the purchaser who purchased the commodities of such combination. Therefore, by analyzing the coordinate records stored in the coordinate database 240, user can easily obtain information that, for example, how to coordinate a jacket with a necktie by the men in their 30's who are about 170 cm high and like M-size clothing.

Further, in the coordinate server 24, the customer feature data, including age, sex, height and clothing size of the requester, sent from the information terminal 32 is compared with the customer feature data recorded in each coordinate record stored in the coordinate database 240 to acquire the data of the combination of commodities which is associated with the customer feature data including features similar to those of the requester. Then, the data of the combination of commodities is output to the information terminal 32. Therefore, in the information terminal 32, the coordinate information of the commodities which were purchased before by a customer having features similar to those of the requester can be easily acquired by only inputting the customer feature data of the requester, thereby providing coordinate information meeting preferences of the requester in a short time.

Further, the coordinate information is provided as an image of the commodities combined. Therefore, the requester can reliably determine whether or not the coordinate is desirable because the requester can image he/she wearing the coordinated clothes.

The present invention is not limited to the embodiments above.

For example, in the embodiment, coordinate images are displayed in the descending order of the similarity, however, the display order of coordinate images is not limited to this. For example, coordinate images may be displayed in the order of purchase date nearest from the present date. Further, the method for calculating the similarity is not limited to the one used in the embodiments above.

Further, the coordinate of two kinds of clothes is described in the embodiments above, however, the present invention can also deal with the coordinate of three and more kinds of clothes, by rearranging the coordinate table 242. Further, the present invention is also applicable to not only the coordinate of clothes but also the coordinate of furniture.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A coordinate supporting apparatus, comprising:
a determination section configured to determine whether or not there is a combination of commodities realizing a given coordinate pattern according to the data of the commodities purchased by a customer; and
a storage section configured to accumulatively store the data of the combination of commodities in association with a customer feature data relating to preferences of the customer who purchases commodities of the combination if the determination section determines that there is a combination of commodities realizing the given coordinate pattern.

2. The coordinate supporting apparatus according to claim 1, further comprising:
an acquisition section configured to compare a person feature data relating to preferences of a person who requests a coordinate support with the customer feature data associated with the data of the combination of commodities of each customer stored in the storage section to acquire the data of a combination of commodities associated with the customer feature data similar to the person feature data; and
an output section configured to output the data of the combination of commodities acquired by the acquisition section.

3. The coordinate supporting apparatus according to claim 2, further comprising:
an image creation section configured to create a coordinate image of commodities according to the data of the combination of commodities acquired by the acquisition section, wherein
the output section outputs the coordinate image created by the image creation section.

4. A coordinate supporting system, comprising:
a server configured to manage a database; and
an information terminal capable of a data communication with the server via a network,
wherein the server includes a determination section configured to determine whether or not there is a combination of commodities realizing a given coordinate pattern according to the data of the commodities purchased by a customer, a storage section configured to store the data of the combination of commodities in association with a customer feature data relating to preferences of the customer who purchases commodities of the combination if the determination section determines that there is a combination of commodities realizing the given coordinate pattern, an acquisition section configured to compare a person feature data relating to preferences of a person who requests a coordinate support with the customer feature data associated with the data of the combination of commodities of each customer stored in the storage section to acquire the data of a combination of commodities associated with the customer feature data similar to the person feature data, and an output section configured to output the data of the combination of commodities acquired by the acquisition section; and the information terminal includes a transmission section configured to transmit a person feature data relating to preferences of the person who requests a coordinate support to the server, and a notification section configured to receive the data of the combination of commodities output from the server to notify it.

5. The coordinate supporting system according to claim 4, wherein
the server includes an image creation section configured to create a coordinate image of the commodities according to the data of the combination of commodities acquired by the acquisition section,
the output unit outputs the coordinate image created by the image creation section,
the information terminal includes a display, and
the notification section displays the coordinate image received from the server on the display.

6. A coordinate supporting method, comprising:
determining whether or not there is a combination of commodities realizing a given coordinate pattern according to the data of the commodities purchased by a customer; and
storing the data of the combination of commodities in association with a customer feature data relating to preferences of the customer who purchases the commodities of the combination if the determination is that there is a combination of commodities realizing the given coordinate pattern.
